(19) United States
(12) Patent Application Publication
(10) Pub. No.: US 2008/0287644 A1
(43) Pub. Date: Nov. 20, 2008

(54) HARDENER FOR EPOXY RESINS, METHOD FOR HARDENING AN EPOXY RESIN AND USE OF THE HARDENER

(75) Inventors: Marcus HUMMEL, Mietingen-Baltringen (DE); Markus SCHROTZ, Ochsenhausen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: UPPC AG, Mietingen-Baltringen (DE)

(21) Appl. No.: 12/062,195

(22) Filed: Apr. 3, 2008

(30) Foreign Application Priority Data
Apr. 5, 2007 (DE) 07 007 213.7

(51) Int. Cl. C09K 3/00; C08G 59/00

(52) U.S. Cl. 528/365; 252/182.18

(57) ABSTRACT

The present invention relates to a hardener for epoxy resins, which on the one hand contains a Michael adduct of a bifunctional amine and of an acrylic acid derivative and also an adduct from a epoxy and the bifunctional amine. The invention likewise relates to a method for hardening an epoxy resin by mixing of a not yet hardened epoxy resin with a Michael adduct of a bifunctional amine and of an acrylic acid derivative. Furthermore, purposes of use of the hardener according to the invention are provided.

Coatings (in general) are produced from coating materials by application thereof (DIN 55945: 1990). The processing has a crucial influence on the properties of the finished coatings. There are cold- and hot-hardening coatings which differ significantly in principle.

Cold-hardening coatings must be hardened at ambient temperature and are not heated after their application in general (if necessary forced drying with heated air); hot-hardening ones are in addition heated or respectively stoved. The hardening time of cold-hardening coatings is dependent upon the composition thereof and the ambient temperature during hardening; it can be up to two weeks and more until serviceability. Hot-hardening coatings are ready for use after the stoving time which in the normal case is less than an hour.

Solvent-containing and solvent-free coatings differ. From solvent-free coating materials, layer thicknesses up to above 2000 μm can be produced with a single application. Solvent-containing coating materials can only be applied in a thin layer since the solvents contained therein must evaporate over the surface via the route of the layer thickness which should be kept as short as possible before the progressing reaction between resin and hardener prevents this.

The coating materials are normally processed by methods, such as painting, dipping, knife application, spraying, knife coating etc.

Coating materials are applied on different materials, such as e.g. steel, aluminium, concrete. In order to achieve a permanently durable coating, possibly coating structures comprising a plurality of layers (base, intermediate and finishing coat) are required as a function of the foundation. The lower layers need not necessarily be epoxy resin and can contain solvents. Until complete hardening of the finishing coat or in the case of holidays or damage occurring, materials could then migrate from the lower layers to the surface and consequently into the environment, for example also into drinking water. For this reason, the sub-layers must also be assessed to be hygienic.

Coating materials generally comprise the following main components:
Binders (resins and hardeners)
Pigments and fillers
Organic modifying agents
Solvents
Additives and aids
Accelerators

The binder can be termed “polymer-specific”. All the other components are not so, i.e. they occur also in other coatings (polymer-independent).

The binder is composed in the case of epoxy resin coatings of resins and hardeners, if necessary also with the addition of non-epoxy-reactive plasticisers (e.g. phthalates), polymeric resins (e.g. polyacrylates) or modifying agents (e.g. benzyl alcohol). Coating systems of this type are therefore termed two-component reaction coating materials in which the hardening is initiated by mixing two components (DIN 55945: 1999).

Epoxy resin is defined in the initial standard DIN V 55650: 1998 as synthetic resin, generally produced from epichlorohydrin and bisphenol A or by epoxidation of specific olefinic double bonds. Epoxy resins contain more than one epoxy group per molecule. As hardeners, there are used amines, amidoamines and amine adducts, the amine hydrogens of which react with the epoxy groups and also isocyanates, (poly)mercaptans or carboxylic acid anhydrides.

For assessment of epoxy resin coatings in contact with drinking water, the guideline for hygienic assessment of epoxy resin coatings in contact with drinking water of 14 Oct. 2005 should be taken into account.

According to this, for the new establishment or maintenance of plants for treating or distributing water for human use, “only substances and materials are used which, in contact with water, do not give off materials in such concentrations which are higher than are unavoidable according to the generally recognised rules of the industry, or directly or indirectly reduce the protection of human health provided according to these regulations, or change the smell or taste of the water; . . . ”.

As a prerequisite for the above-mentioned certifications, the producer must present both a test certificate according to this guideline and a test certificate relating to the microbiological suitability of the coating system according to the DVGW (German Technical and Scientific Association for Gas and Water) working paper W 270.

Like the recommendation “Assessment with respect to health of plastic materials and other non-metallic materials within the framework of the food and consumer goods law for the drinking water field (KTW recommendations)”, the guideline is composed of three parts, the positive lists of usable starting materials for the production of substances and materials, the prescribed test procedures (migration test procedure) and the test values to be maintained within the tests with a boundary value character. This therefore corresponds also to the principle structure of the future “European acceptance system for building products in contact with drinking water (EAS)”.

Many hardeners for epoxy resins are already known from the state of the art. For example WO 2005/123802 A1 discloses a hardener for epoxy resins which however includes acrylonitrile as a compulsory component. Acrylonitrile is however a highly toxic and carcinogenic substance and must therefore not be used with epoxy resins which are intended to be suitable for application in drinking water systems.

US 2004/0048985 A1 discloses Michael addition adducts of polyfunctional acrylates and amino-terminated polyolefins. The acrylate is hereby at least bifunctional. A polymer which contains terminal double bonds and secondary amino groups is obtained. It should therefore be suitable only in a restricted manner for cross-linking of epoxy resins.

In the Japanese printed patent specification 4-330044, a Michael addition product of n-butylacrylate and m-xylylenediamine is described in the production of plastic materials.

It is hence the object of the present invention to provide an epoxy hardener which is as non-toxic as possible, as non-etching as possible and conforming to the KTW guideline. Furthermore, the hardener is intended to have as positive as possible properties, such as high resistance and good processibility. It is furthermore the object of the present invention to provide a method which is as simple and economical as possible for hardening epoxy resins.

This object is achieved with respect to the hardener with the features of patent claim 1, with respect to the method with the features of patent claim 15. Possibilities of use of the hardener are mentioned in claim 24. The dependent claims thereby represent advantageous developments.

According to the invention, a hardener for epoxy resins is hence provided, containing as component a) at least one at least simple Michael adduct of an at least bifunctional amine (A) and an acrylic acid derivative, the amine (A) being selected from the group comprising 1-amino-3-aminomethyl-3,5,5-trimethylcyclohexane (IPD), 1,3-benzenedimethanamine (MXDA), bis(4-aminocyclohexyl)methane, bis(4-aminophenyl)methane, 1,4-diaminobutane, 2-methyl-1,5-diaminopentane (MPMD), dimethylaminoethanol, hexamethylenediamine, a mixture of 1,6-diamino-2,2,4-trimethylhexane and 1,6-diamino-2,4,4-trimethylhexane (TMD), 1,3-phenylenediamine, 2,4,6-triamino-1,3,5-triazine, 1,2-diaminocyclohexane (DCH), 1,3-propanediamine, ethylenediamine (EDA), diethylenetriamine (DETA), triethylenetetramine (TETA), tetraethylenepentamine (TEPA), pentaethylenehexamine (PEHA), N-ethylaminopiperazine (N-AEP), dipropylenetriamine (DPTA), polyoxypropylenediamine, polyoxypropylenetriamine, 1,3-bisaminomethylcyclohexane (1,3-BAC), 3-(2-aminoethyl)-aminopropylamine (N₃-amine), N,N′-bis(3-aminopropyl)-ethylenediamine (N₄-amine), 1,3-2,5(2,6)-bis-(aminomethyl)-bicyclo[2.2.1]heptane (NBDA), bis(aminomethyl)-tricyclodecane (TCD-amine); and in addition as component b) at least one adduct comprising an epoxy and the at least bifunctional amine (A).

It has been shown that component a) (Michael adduct) of the hardener has particularly advantageous properties with respect to thermal stability. It is known that acrylonitrile-amine-adducts have low thermal stability, and a Michael reversion takes place after approx. 60° C. These temperatures can occur easily during hardening of reactive epoxy resins. Hence when using acrylonitrile-containing epoxy hardeners, partial release of the highly toxic acrylonitrile into the environment, for example air or drinking water takes place. The above-mentioned Michael adducts of the hardener according to the invention are characterised by high thermal stability, a Michael reversion being able to be observed here only after approx. 150° C. Hence the Michael adducts are stable under the conditions of use, namely during hardening of an epoxy resin, and release no toxic and/or etching degradation products into the environment.

In an advantageous development, the acrylic acid derivative corresponds to the general formula I,

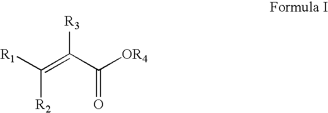

R₁, R₂, R₃ and R₄ being selected independently of each other from the group comprising hydrogen, linear or branched aliphatic radicals with 1 to 18 carbon atoms, linear or branched araliphatic radicals with 1 to 18 carbon atoms and/or aromatic or heteroaromatic radicals with 6 to 20 carbon atoms.

It is further preferred if the amine (A) is MXDA and if the acrylic acid derivative corresponds to the general formula II,

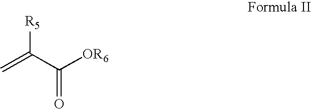

R₅ being selected from the group comprising hydrogen or methyl and R₆ being selected from linear or branched aliphatic radicals with 1 to 12 carbon atoms.

It is preferred in particular if component a) of the hardener (Michael adduct) corresponds to Formula III, i.e. is formed by the addition of MXDA and n-butylacrylate.

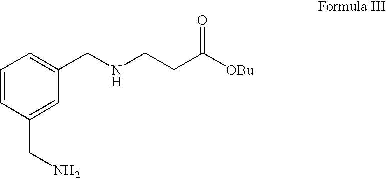

In the case of component b) of the hardener, the epoxy is selected preferably from the group comprising p.t.-butylphenylglycidylether, o-cresylglycidylether, phenylglycidylether, primary, secondary and/or tertiary butylglycidylether, C₁₂/C₁₄ and/or C₁₃/C₁₅-fatty acid glycidylether, 2-ethylhexylglycidylether, 2-propylheptylglycidylether, ethylene oxide, propylene oxide, butylene oxide, epichlorohydrin and/or glycidol.

The advantageous properties of the hardener are not thereby dependent upon the mixture ratio of components a) and b). Advantageously, the mixture ratio of components relative to the mass ratio is however between 95:5 and 5:95, preferably between 70:30 and 30:70, particularly preferred between 60:40 and 40:60.

Fine adjustment of the properties of the hardener can be effected in that free amine groups which are contained in the composition are capped by addition of an epoxy. The epoxy is thereby selected preferably from the group comprising p.t.-butylphenylglycidylether, o-cresylglycidylether, phenylglycidylether, primary, secondary and/or tertiary butylglycidylether, C₁₂/C₁₄ and/or C₁₃/C₁₅-fatty acid glycidylether, 2-ethylhexylglycidylether, 2-propylheptylglycidylether, ethylene oxide, propylene oxide, butylene oxide, epichlorohydrin, glycidol, bisphenol A, F-diglycidylether and/or mixtures thereof. The epoxy can be used thereby, with respect to the quantity of material of the free amino groups in the composition, substoichiometrically, stoichiometrically but also superstoichiometrically, according to which properties of the hardener are desired.

It is of advantage in particular if the hardener contains as low as possible a proportion of free amine (A) relative to the total quantity of the hardener. There is understood according to the invention by free amine that the amine is present not as adduct, for example with an acrylate or epoxy, but is uncombined in the composition.

In particular, the proportion of free amine (A) is thereby less than 20% by weight, prefereably less than 10% by weight, particularly preferred less than 5% by weight, however also smaller quantities, such as for example <2.5% by weight or <2% by weight are possible and favourable. The low proportion of free amine (A) thereby reduces the etching properties of the hardener so that the classification of the hardener can be effected not as etching but as irritant. Also the dangers and safety measures during application are reduced as a result of a low amine component.

Furthermore, it is of advantage if the hardener contains no volatile organic components (VOC), in particular benzyl alcohol. It is likewise ensured consequently that the composition gives off no toxins to the environment after hardening.

In particular, easily releasable toxic substances, such as for example acrylonitrile, can be dispensed with in the hardener. Hence the composition need not be classified as toxic under specific conditions, the advantages of non-toxic compositions naturally resulting.

The hardener can thereby also contain the normal further additives which are known to the person skilled in the art, in particular accelerators, modifying agents, flow improvers, dispersion agents, wetting agents and/or mixtures thereof.

Advantageously, the amine hydrogen equivalent of the hardener is at most 1,000 g/H equivalent, preferably at most 500 g/H equivalent, particularly preferred at most 250 g/H equivalent.

Surprisingly, it was shown that the hardener is characterised positively by its low viscosity. In particular, the viscosity at 25° C. is thereby less than 20,000 mPas, preferably less than 5,000 mPas, particularly preferred less than 1,000 mPas. This offers the advantage in particular that the composition can be applied for example during the hardening of epoxy resins without further dilution by for example the addition of organic solvents since the epoxy resins can then be diluted by the hardener.

Likewise, it was shown surprisingly that the hardener has a bright intrinsic colour. Measured on the Gardner colour scale, the colouration is between 0 and 10 Gardner, preferably between 0 and 5 Gardner.

A method is likewise provided for hardening an epoxy resin in which mixing of a composition is effected, containing at least one at least simple Michael adduct of an at least bifunctional amine (A) and an acrylic acid derivative, the amine (A) being selected from the group comprising 1-amino-3-aminomethyl-3,5,5-trimethylcyclohexane (IPD), 1,3-benzenedimethanamine (MXDA), bis(4-aminocyclohexyl)methane, bis(4-aminophenyl)methane, 1,4-diaminobutane, 2-methyl-1,5-diaminopentane (MPMD), dimethylaminoethanol, hexamethylenediamine, a mixture of 1,6-diamino-2,2,4-trimethylhexane and 1,6-diamino-2,4,4-trimethylhexane (TMD), 1,3-phenylenediamine, 2,4,6-triamino-1,3,5-triazine, 1,2-diaminocyclohexane (DCH), 1,3-propanediamine, ethylenediamine (EDA), diethylenetriamine (DETA), triethylenetetramine (TETA), tetraethylenepentamine (TEPA), pentaethylenehexamine (PEHA), N-ethylaminopiperazine (N-AEP), dipropylenetriamine (DPTA), polyoxypropylenediamine, polyoxypropylenetriamine, 1,3-bisaminomethylcyclohexane (1,3-BAC), 3-(2-aminoethyl)-aminopropylamine (N₃-amine), N,N′-bis(3-aminopropyl)ethylenediamine (N₄-amine), 1,3-2,5(2,6)-bis-(aminomethyl)-bicyclo[2.2.1]heptane (NBDA), bis(aminomethyl)-tricyclodecane (TCD-amine) with at least one not yet hardened epoxy resin.

The composition of any epoxy resins is thereby suitable, however the epoxy resin is preferably selected from the group comprising bisphenol A-diglycidylether, bisphenol F-diglycidylether, epox. phenolnovolaks, epox. cresolnovolaks and/or mixtures thereof.

The method can then be implemented particularly advantageously when the not yet hardened epoxy resin is diluted reactively with a low molecular epoxy compound.

It should be mentioned as a further advantage of the method that, during the hardening process and subsequent thereto, no toxic materials, in particular degradation products of the substances used, are released.

It was shown surprisingly that, by using the Michael adduct as hardener for epoxy resins, particularly favourable pot times are produced. The pot times are, in particular between 5 min and 600 min, preferably between 15 min and 300 min, particularly preferred between 30 min and 180 min.

Likewise the implementation of the hardening method is possible within a broad temperature spectrum, which is a further advantageous property of the present invention. The external temperatures can thereby be between −5° C. and 50° C.

The mixing ratio of the Michael adduct with the at least one not yet hardened epoxy resin is thereby advantageously between 1.2:1 and 1:1.2, preferably between 1.1:1 and 1:1.1, particularly preferred between 1.05:1 and 1:1.05 H-equivalents:epoxy equivalents.

Advantageously, the use of acrylonitrile is dispensed with during implementation of the method.

Advantages are produced in particular if the initially described hardener is used during implementation of the method.

Possibilities for use of a composition which contains at least one at least simple Michael adduct of an at least bifunctional amine and of an acrylic acid derivative, the amine being selected from the group comprising 1-amino-3-aminomethyl-3,5,5-trimethylcyclohexane (IPD), 1,3-benzenedimethanamine (MXDA), bis(4-aminocyclohexyl)methane, bis(4-aminophenyl)methane, 1,4-diaminobutane, 2-methyl-1,5-diaminopentane (MPMD), dimethylaminoethanol, hexamethylenediamine, a mixture of 1,6-diamino-2,2,4-trimethylhexane and 1,6-diamino-2,4,4-trimethylhexane (TMD), 1,3-phenylenediamine, 2,4,6-triamino-1,3,5-triazine, 1,2-diaminocyclohexane (DCH), 1,3-propanediamine, ethylenediamine (EDA), diethylenetriamine (DETA), triethylenetetramine (TETA), tetraethylenepentamine (TEPA), pentaethylenehexamine (PEHA), N-ethylaminopiperazine (N-AEP), dipropylenetriamine (DPTA), polyoxypropylenediamine, polyoxypropylenetriamine, 1,3-bisaminomethylcyclohexane (1,3-BAC), 3-(2-aminoethyl)-aminopropylamine (N₃-amine), N,N′-bis(3-aminopropyl)-ethylenediamine (N₄-amine), 1,3-2,5-(2,6)-bis-(aminomethyl)-bicyclo[2.2.1]heptane (NBDA), bis(aminomethyl)-tricyclodecane (TCD-amine), are application possibilities as hardeners, accelerators, plasticisers and/or bonding agents for reactive polymers. The same possibilities of use are likewise provided for the initially described hardener.

The reactive polymers are thereby selected in particular from the group comprising epoxy resins, polyurethanes, polyesters and/or aminoplasts.

### EXAMPLE 1

### Michael Adduct

There are added in drops to 228 g MXDA (1.7 mol) at 30° C., 254 g n-butylacrylate (2 mol) within 4 h. After conclusion of the addition in drops, it is left to react further for 4 h at 30° C. and for 16 h at room temperature.

A low viscous, slightly yellowish-coloured liquid is obtained with a smell characteristic of saturated esters. Viscosity (25° C.)=29 mPas, amine value=390 mg KOH/g, Gardner colour number: 1.5.

### EXAMPLE 2

### Isolated Amine Adduct

There are added in drops to 206 g DETA (2 mol) at 80° C., 230 g p.-t.-butylglycidether (1 mol) within 2 h. After conclusion of the addition in drops, further agitation takes place for a further 2 h at the same temperature, then a vacuum of 10 mbar is applied and the temperature increased slowly to 170° C. 103 g DETA were thereby distilled.

A viscous, opaque, slightly yellowish-coloured liquid is obtained, with an aminic smell. Viscosity (25° C.)=110′000 mPas, amine value=410 mg KOH/g, Gardner colour number: 3.5.

### EXAMPLE 3

### Hardener According to the Invention

38.3 g of the Michael adduct from example 1 are mixed with 33.7 g of the isolated amine adduct from example 2 at room temperature. A hardener for epoxy resins with the following properties is obtained: amine equivalent=107 g/equiv., viscosity (25° C.)=360 mPas, Gardner colour number=2.5.

### EXAMPLE 4

### Testing of the Hardener from Example 3

64 g of a reactive-diluted epoxy resin with an epoxy equivalent weight of 193 g/equivalent (Polypox E 403, UPPC AG) are mixed intensively at 23° C. with 36 g of the hardener from example 3 for 2 min.

This mixture is left to harden in a thermally isolated vessel and the time is measured until a strong viscosity increase is effected, in this case after 160 min (pot time).

In another experiment, an analogous mixture is cast in moulds directly after the 2 min mixing time to form a 2 mm thick film which hardens in different climatic conditions. The films are assessed with respect to their hardness development (Shore D hardness) and surface properties after complete hardening.

### RESULTS

At 23° C./50% rel. air humidity, a Shore D hardness of 55 is achieved already after 21 h hardening. The end value of 73 is achieved after 40 h.

The surface is very slightly imperfect, shows typical shine and is tack-free.

At 13° C./80% rel. air humidity, a Shore D hardness of 55 is achieved already after 45 h hardening. The end value of 73 is achieved after 64 h.

The surface is slightly imperfect, shows typical shine and is tack-free.

At 7° C./50% rel. air humidity, a Shore D hardness of 40 is achieved already after 48 h hardening. The end value of 56 is achieved after 64 h.

The surface is imperfect, satin and slightly tacky.

1. A hardener for epoxy resins, containing
a) at least one at least simple Michael adduct of an at least bifunctional amine (A) and an acrylic acid derivative, the amine (A) being selected from the group comprising 1-amino-3-aminomethyl-3,5,5-trimethylcyclohexane (IPD), 1,3-benzenedimethanamine (MXDA), bis(4-aminocyclohexyl)methane, bis(4-aminophenyl)methane, 1,4-diaminobutane, 2-methyl-1,5-diaminopentane (MPMD), dimethylaminoethanol, hexamethylenediamine, a mixture of 1,6-diamino-2,2,4-trimethylhexane and 1,6-diamino-2,4,4-trimethylhexane (TMD), 1,3-phenylenediamine, 2,4,6-triamino-1,3,5-triazine, 1,2-diaminocyclohexane (DCH), 1,3-propanediamine, ethylenediamine (EDA), diethylenetriamine (DETA), triethylenetetramine (TETA), tetraethylenepentamine (TEPA), pentaethylenehexamine (PEHA), N-ethylaminopiperazine (N-AEP), dipropylenetriamine (DPTA), polyoxypropylenediamine, polyoxypropylenetriamine, 1,3-bisaminomethylcyclohexane (1,3-BAC), 3-(2-aminoethyl)-aminopropylamine (N₃-amine), N,N′-bis(3-aminopropyl)-ethylenediamine (N₄-amine), 1,3-2,5(2,6)-bis-(aminomethyl)-bicyclo[2.2.1]heptane (NBDA), bis(aminomethyl)-tricyclodecane (TCD-amine); and in addition
b) at least one adduct comprising an epoxy and the at least bifunctional amine (A).

2. The hardener according to claim 1, wherein the acrylic acid derivative corresponds to the general formula I, 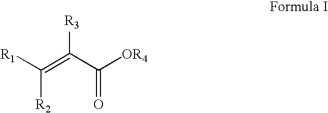
R₁, R₂, R₃ and R₄ being selected independently of each other from the group comprising hydrogen, linear or branched aliphatic radicals with 1 to 18 carbon atoms, linear or branched araliphatic radicals with 1 to 18 carbon atoms and/or aromatic or heteroaromatic radicals with 6 to 20 carbon atoms.

3. The hardener according to claim 1, wherein the amine is MXDA and the acrylic acid derivative corresponds to the general formula II, 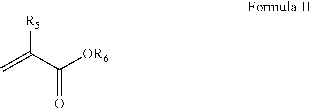
R₅ being selected from the group comprising hydrogen or methyl and
R₆ being selected from linear or branched aliphatic radicals with 1 to 12 carbon atoms.

4. The hardener according to claim 1, wherein the Michael adduct corresponds to Formula III:

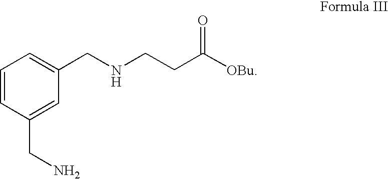

5. The hardener according to claim 1, wherein the epoxy is selected from the group comprising p.t.-butylphenylglycidylether, o-cresylglycidylether, phenylglycidylether, primary, secondary and/or tertiary butylglycidylether, C₁₂/C₁₄ and/or C₁₃/C₁₅-fatty acid glycidylether, 2-ethylhexylglycidylether, 2-propylheptylglycidylether, ethylene oxide, propylene oxide, butylene oxide, epichlorohydrin and/or glycidol.

6. The hardener according to claim 1, wherein the mixture ratio between the Michael adduct and the adduct from one epoxy and the at least bifunctional amine relative to the mass ratio is between 95:5 5:95.

7. The hardener according to claim 1, wherein the at least simple Michael adduct of an at least bifunctional amine (A) and of an acrylic acid derivative and/or the at least one adduct from an epoxy and the at least bifunctional amine (A) is end-capped with an epoxy, selected from the group comprising p.t.-butylphenylglycidylether, o-cresylglycidylether, phenylglycidylether, primary, secondary and/or tertiary butylglycidylether, C₁₂/C₁₄ and/or C₁₃/C₁₅-fatty acid glycidylether, 2-ethylhexylglycidylether, 2-propylheptylglycidylether, ethylene oxide, propylene oxide, butylene oxide, epichlorohydrin, glycidol, bisphenol A-diglycidylether, bisphenol F-diglycidylether and/or mixtures thereof, or by reaction with ethylenically unsaturated monomers or aldehydes.

8. The hardener according to claim 1, wherein the proportion of free amine (A) relative to the total mass is less than 20% by weight.

9. The hardener according to claim 1, wherein it contains no volatile organic components (VOC).

10. The hardener according to claim 1, wherein it is free of acrylonitrile.

11. The hardener according to claim 1, wherein further additives are contained, selected from the group comprising accelerators, modifying agents, flow improvers, dispersion agents, wetting agents and/or mixtures thereof.

12. The hardener according to claim 1, wherein the amine hydrogen equivalent weight is at most 1,000 g/H equivalent.

13. The hardener according to claim 1, wherein the viscosity thereof at 25° C. is less than 20,000 mPas.

14. The hardener according to claim 1, wherein it contains a colouration according to Gardner colour scale between 0 and 10 Gardner.

15. A method for hardening an epoxy resin by mixing a composition containing at least one at least simple Michael adduct of an at least bifunctional amine (A) and an acrylic acid derivative, the amine (A) being selected from the group comprising 1-amino-3-aminomethyl-3,5,5-trimethylcyclohexane (IPD), 1,3-benzenedimethanamine (MXDA), bis(4-aminocyclohexyl)methane, bis(4-aminophenyl)methane, 1,4-diaminobutane, 2-methyl-1,5-diaminopentane (MPMD), dimethylaminoethanol, hexamethylenediamine, a mixture of 1,6-diamino-2,2,4-trimethylhexane and 1,6-diamino-2,4,4-trimethylhexane (TMD), 1,3-phenylenediamine, 2,4,6-triamino-1,3,5-triazine, 1,2-diaminocyclohexane (DCH), 1,3-propanediamine, ethylenediamine (EDA), diethylenetriamine (DETA), triethylenetetramine (TETA), tetraethylenepentamine (TEPA), pentaethylenehexamine (PEHA), N-ethylaminopiperazine (N-AEP), dipropylenetriamine (DPTA), polyoxypropylenediamine, polyoxypropylenetriamine, 1,3-bisaminomethylcyclohexane (1,3-BAC), 3-(2-aminoethyl)-aminopropylamine (N₃-amine), N,N′-bis(3-aminopropyl)ethylenediamine (N₄-amine), 1,3-2,5(2,6)-bis-(aminomethyl)-bicyclo[2.2.1]heptane (NBDA), bis(aminomethyl)-tricyclodecane (TCD-amine) with at least one not yet hardened epoxy resin.

16. The method according to claim 15, wherein the at least one epoxy resin is selected from the group comprising bisphenol A-diglycidylether, bisphenol F-diglycidylether, epox. phenolnovolaks, epox. cresolnovolaks and/or mixtures thereof.

17. The method according to claim 15, wherein the not yet hardened epoxy resin is diluted reactively with a low molecular epoxy compound.

18. The method according to claim 15, wherein during the hardening process and subsequent thereto, no toxic materials are released.

19. The method according to claim 15, wherein the pot time is between 5 min and 600 min.

20. The method according to claim 15, wherein it is implemented at external temperatures between −5° C. and 50° C.

21. The method according to claim 15, wherein the mixing ratio of the composition with the at least one not yet hardened epoxy resin is between 1.2:1 and 1:1.2 H-equivalents:epoxy equivalents.

22. The method according to claim 15, wherein the composition is free of acrylonitrile.

23. The method according to claim 15, wherein a hardener further includes at least one adduct comprising an epoxy and the at least bifunctional amine (A).

24. A composition containing at least one at least simple Michael adduct of an at least bifunctional amine and of an acrylic acid derivative, the amine being selected from the group comprising 1-amino-3-aminomethyl-3,5,5-trimethylcyclohexane (IPD), 1,3-benzenedimethanamine (MXDA), bis(4-aminocyclohexyl)methane, bis(4-aminophenyl)methane, 1,4-diaminobutane, 2-methyl-1,5-diaminopentane (MPMD), dimethylaminoethanol, hexamethylenediamine, a mixture of 1,6-diamino-2,2,4-trimethylhexane and 1,6-diamino-2,4,4-trimethylhexane (TMD), 1,3-phenylenediamine, 2,4,6-triamino-1,3,5-triazine, 1,2-diaminocyclohexane (DCH), 1,3-propanediamine, ethylenediamine (EDA), diethylenetriamine (DETA), triethylenetetramine (TETA), tetraethylenepentamine (TEPA), pentaethylenehexamine (PEHA), N-ethylaminopiperazine (N-AEP), dipropylenetriamine (DPTA), polyoxypropylenediamine, polyoxypropylenetriamine, 1,3-bisaminomethylcyclohexane (1,3-BAC), 3-(2-aminoethyl)-aminopropylamine (N3-amine), N,N′-bis(3-aminopropyl)-ethylenediamine (N₄-amine), 1,3-2,5(2,6)-bis-(aminomethyl)-bicyclo[2.2.1]heptane (NBDA), bis(aminomethyl)-tricyclodecane (TCD-amine), and a reactive polymer.

25. (canceled)

26. The composition of claim 24, wherein the reactive polymer is selected from the group comprising epoxy resins, polyurethanes, polyesters and/or aminoplasts.
